(19) United States
(12) Patent Application Publication
(10) Pub. No.: US 2024/0260660 A1
(43) Pub. Date: Aug. 8, 2024

(54) Heating Assembly for an Aerosol Generating Device

(71) Applicant: JT International SA, Geneva (CH)

(72) Inventors: Ernst Hupkes, Kampen (NL); Dick Paul Voerman, Apeldoorn (NL)

(73) Assignee: JT International SA, Geneva (CH)

(21) Appl. No.: 18/275,139

(22) PCT Filed: Jan. 25, 2022
(86) PCT No.: PCT/EP2022/051546

§ 371 Date: Jul. 31, 2023

(30) Foreign Application Priority Data
Feb. 8, 2021 (EP) 21155871.3

(51) Int. Cl. A24F 40/46; H05B 3/46

(52) U.S. Cl. CPC A24F 40/46; H05B 3/46; H05B 2203/003

(57) ABSTRACT

A heating assembly for an aerosol generating device includes a heating chamber having an opening for receiving an aerosol substrate. A coating of electrically insulating material is formed on a surface of the heating chamber. A coating of electrically conductive material at least partially coats the coating of electrically insulating material. The coating of electrically conductive material is configured to act as a Joule heater when supplied with electrical current. The coating of electrically insulating material prevents any contact between the coating of electrically conductive material and the heating chamber.

The present invention relates to a heating assembly for an aerosol generating device. The disclosure is particularly applicable to a portable aerosol generation device, which may be self-contained and low temperature. Such devices may heat, rather than burn, tobacco or other suitable aerosol substrate materials by conduction, convection, and/or radiation, to generate an aerosol for inhalation.

The popularity and use of reduced-risk or modified-risk devices (also known as vaporisers) has grown rapidly in the past few years as an aid to assist habitual smokers wishing to quit using traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn (HNB) device. Devices of this type generate an aerosol or vapour by heating an aerosol substrate (i.e. consumable) that typically comprises moist leaf tobacco or other suitable aerosolisable material to a temperature typically in the range of 150° C. to 300° C. Heating an aerosol substrate, but not combusting or burning it, releases an aerosol that comprises the components sought by the user but not the undesirable by-products of combustion. In addition, the aerosol produced by heating the tobacco or other aerosolisable material does not typically comprise the burnt or bitter taste that may result from combustion that can be unpleasant for the user.

Within known heat-not-burn devices, it is desirable to improve the efficiency of the heating process, whilst also ensuring a reliable operation of the device. It is also desirable to improve the ease of manufacturing the heating assembly.

According to a first aspect of the invention, there is provided a heating assembly for an aerosol generating device, comprising: a heating chamber having an opening for receiving an aerosol substrate; a coating of electrically insulating material that is formed on a surface of the heating chamber; and a coating of electrically conductive material that at least partially coats the coating of electrically insulating material, wherein the coating of electrically conductive material is configured to act as a Joule heater when supplied with electrical current, and wherein the coating of electrically insulating material prevents any contact between the coating of electrically conductive material and the heating chamber.

In this way, the energy efficiency of the heating assembly is significantly improved. In particular, as the layers of electrically insulating material and electrically conductive material are formed as coatings which form a direct bond (e.g. chemical bond) to the layer beneath, there are no air gaps or other thermal breaks between the layers which would otherwise result in thermal losses. This leads to improvements in the heat-up time and cool-down time of the heating chamber, whilst also providing a reliable and compact heating assembly. In contrast, within conventional heating assemblies for aerosol generating devices, a heating element is typically disposed on a dielectric backing film and attached to a heating chamber using polymer wrapping such as a heat shrink film. This configuration of wrapped layers leads to significant thermal losses due to the presence of air gaps. Moreover, the requirement to wrap conventional assemblies in plastic film necessitates a manual production process. By utilising a coating of electrically conductive material as the heating element, a plastic wrap is no longer required to secure the heating layer to the heating assembly, thereby allowing the production of the heating assembly to occur using an automated process, rather than a manual process. In addition, the use of a coating, rather than a discrete pre-formed heating element, allows for improved flexibility with regards to the shape and resulting properties of the heating layer. For example, the coating of electrically conductive material conforms to the specific morphology of the underlying surface, in contrast to a pre-formed heating element which does not form as closely to the surface thereby leading to suboptimal heat transfer.

The term “coating” refers to a layer that is formed during its application on a substrate. For example, the coating of electrically insulating material is formed during application of the electrically insulating material to the surface of the heating chamber. Similarly, the coating of electrically conductive material is formed during application of the electrically conductive material to the coating of electrically insulating material. Each coating does not exist as a discrete layer prior to its application. In particular, the coating may be defined as a layer formed by the application of a liquid, vapour or gaseous material to the underlying substrate. This contrasts with films such as PEEK or polyimide films, or conventional heating tracks, which are pre-formed and exist as discrete layers prior to their application.

Preferably, the coating of electrically insulating material is formed as a rigid layer on the surface of the heating chamber. In contrast, conventional electrically insulating films such as PEEK or polyimide are attached as a flexible layer on the surface of the heating chamber.

Preferably, the coating of electrically conductive material is formed on the coating of electrically insulating material.

Preferably, the heating chamber is tubular and the coating of electrically insulating material is formed on a circumferential surface of the heating chamber.

Alternatively, the heating chamber is shaped as a plate or is “C”-shaped. In this case, the coating of electrically insulating material may be formed on the convex part of the heating chamber.

Preferably, the coating of electrically conductive material is chemically bonded to the coating of electrically insulating material. That is, the coating of electrically insulating conductive material 208 forms its own chemical bonds with the coating of electrically insulating material 206, thereby removing the requirement for an adhesive or other bonding material.

Preferably, the coating of electrically conductive material is deposited on the coating of electrically insulated material by physical or chemical deposition.

Preferably, the coating of electrically conductive material is metal or metal oxide.

In a possible alternative, the coating of electrically conductive material is non-metal, preferably carbon.

Preferably, the coating of electrically conductive material is formed as a meandrous pattern on the coating of electrically insulating material. In this way, the coating of electrically conductive material is able to provide a uniform distribution of heat to the aerosol substrate whilst remaining energy efficient. Moreover, the thermal properties of the coating of electrically conductive material may be tailored according to the operational requirements of the heating assembly, by forming the coating of electrically conductive material in different patterns. Specific patterns may also be formed to provide the coating of electrically insulating material with additional functions, for example a thermistor or antenna function. The pattern may form a single heater track or path or two or more heater tracks or paths that can be heated independently or simultaneously.

Preferably, the coating of electrically conductive material is formed as an unbroken surface that entirely surrounds the coating of electrically insulating material in a circumferential direction of the heating chamber. In this way, the manufacturing process is simplified whilst ensuring that the aerosol substrate received within the heating chamber receives a uniform distribution of heat.

Preferably, the coating of electrically conductive material is formed as a plurality of circumferentially spaced bands that extend in an axial direction of the heating chamber. In this way, the coating of electrically conductive material may be selectively applied, e.g. by a metal evaporation process, to provide focused heating zones dependent on the configuration of the heating chamber and/or aerosol substrate. For example, the bands may be located corresponding to recessed regions and/or flat regions of the heating chamber.

Preferably, the circumferential surface of the heating chamber on which the coating of electrically insulating material is formed is an outer surface of the heating chamber. In this way, the coating of electrically conductive material is disposed on the exterior of the heating assembly such that, during operation, heat is generated in the coating of electrically conductive material and conducted across the coating of electrically insulating material to the heating chamber, thereby heating the aerosol substrate received within the heating chamber.

Preferably, the circumferential surface of the heating chamber on which the coating of electrically insulating material is formed is an inner surface of the heating chamber. The inner surface of the heating chamber is a surface facing the cavity for receiving, via the opening, at least part of the aerosol generating article. In this way, the coating of electrically conductive material is disposed within the interior of the heating chamber such that, during operation, the aerosol substrate received within the heating chamber interfaces with the coating of electrically conductive material and is directly heated by the coating of electrically conductive material.

Preferably, the heating assembly further comprises a first electrode connected to a first axial end of the coating of electrically conductive material and a second electrode connected to a second opposing axial end of the coating of electrically conductive material such that, in use, electrical current may flow from the first electrode to the second electrode via the coating of electrically conductive material.

Preferably, the first electrode and the second electrode are each formed as a ring that surrounds the heating chamber in a circumferential direction. In this way, a compact and robust configuration of electrodes is provided. Moreover, as each electrode directly interfaces with the coating of electrically conductive material around the heating chamber, focused heating areas may be produced.

Preferably, the heating assembly comprises local contacts of a third material on the surface of the coating of electrically conductive material. These local contacts may form spots for easy brazing or soldering electrical wires with a brazing material such as with lead or silver. The third material is selected for its ability to be fixed, e.g. coated, on the electrically conductive material and be brazed with a brazing material. The local contacts can be gold or nickel or other metals. The third material can be applied by electroplating for example.

Preferably, the coating of electrically conductive material has a thickness of less than 100 microns. In an example, the thickness is less than 50 microns, for example, between 5 and 45 microns. In this way, a thin and energy efficient heating layer is provided.

Preferably, the outer surface of the heating chamber has one or more recessed regions that extend in an axial direction of the heating chamber. In this way, the regions may protrude inwardly towards the interior of the heating chamber, thereby increasing the level of contact between the heating chamber and the aerosol substrate received within the heating chamber.

Preferably, the coating of electrically conductive material is formed coincident to the one or more recessed regions. In this way, the coating of electrically conductive material may preferentially heat portions of the aerosol substrate which are adjacent to the recessed regions, for example portions of the aerosol substrate which are contacted by the inward protrusions. Preferably, the coating of electrically conductive material is further formed between two or more recessed regions. In this way, the coating of electrically conductive material also heats portions of the aerosol substrate located between the portions of the aerosol substrate which are contacted by the inward protrusions.

Preferably, the coating of electrically insulating material comprises one or more of: ceramic, silicone, glass, silicone oxide, carbon, and diamond-like carbon (DLC). In this way, the coating of electrically insulating material exhibits a high electric breakdown voltage and high thermal conductivity in comparison to, for example, polyimide which is often used within conventional electrically insulating films. Such materials also allow for a thin coating to be used, thereby providing improved heat transfer to the aerosol substrate received within the heating chamber. These properties advantageously reduce the heat-up time and cool-down time of the heating chamber, and improve the energy efficiency of the heating assembly. Moreover, such materials exhibit a higher thermal stability than polyimide.

Preferably, the coating of electrically insulating material is deposited using plasma enhanced chemical vapour deposition. Preferably, depositing the layer of electrically insulating material using plasma enhanced chemical vapour deposition comprises using a radio frequency electrical excitation source and a carrier gas comprising CH₄ to deposit a thin film comprising diamond-like-carbon, DLC, or diamond. Preferably, the coating of electrically conductive material is deposited using one of: chemical deposition; physical deposition; ink jet; or gravure. For example, the coating of electrically conductive material may be applied using, thermal evaporation, vacuum evaporation, metal beam evaporation, sputtering, pulsed laser deposition, chemical vapor deposition (CVD), or Arc-PVD (cathodic arc deposition).

Preferably, the coating of electrically conductive material is formed as a meandrous pattern on the coating of electrically insulating material using one of: etching, masking, laser cutting, or screen printing.

Preferably, the coating of electrically conductive material comprises (and optionally consists of) titanium. In another example, the coating of electrically insulating material may comprise (and optionally consists of) silver or silver ink.

Preferably, the coating of electrically insulating material has a thickness of 0.3 to 10 microns. In this way, the efficiency of heat transfer across the coating of electrically insulating material is improved, whilst ensuring the heating chamber remains properly electrically insulated.

Preferably, the heating chamber comprises one or more flattened regions that extend in an axial direction of the heating chamber. In this way, the one or more flattened regions act to compress an outer surface of an aerosol substrate received within the heating chamber, resulting in a closer and more consistent contact between the one or more flattened regions and the aerosol substrate.

This provides improved heat transfer from the heating chamber to the aerosol substrate.

For example, the radius of the heating chamber in the direction of the one or more flattened regions may be smaller than the radius of an (e.g. cylindrical) aerosol substrate received within the heating chamber, such that the one or more flattened regions compress one or more adjacent portions of the aerosol substrate. In contrast, the radius of the heating chamber in the direction of the one or more curved regions (i.e. the regions of the heating chamber between the flattened regions, which define the generally cylindrical shape of the heating chamber) may be the same or less than the radius of the (e.g. cylindrical) aerosol substrate received within the heating chamber, such that the one or more curved regions do not compress adjacent portions of the aerosol substrate. Advantageously, one or more airflow channels may therefore be defined along the length of the heating chamber between the one or more curved regions and the aerosol substrate.

Preferably, the coating of electrically insulating material is formed on the one or more flattened regions. Thus, the coating of electrically conductive material which is formed on the coating of electrically insulating material is also located adjacent to the one or more flattened regions. In one example, the coating of electrically insulating material may be formed on an inner surface of the one or more flattened regions of the heating chamber. In another example, the coating of electrically insulating material may be formed on an outer surface of the one or more flattened regions of the heating chamber.

Preferably, the heating chamber comprises two separable body sections.

According to a second aspect of the invention, there is provided a method of manufacturing a heating assembly according to the first aspect.

Preferably, the method of manufacturing comprises: providing a heating chamber having an opening for receiving an aerosol substrate, wherein a coating of electrically insulating material is formed on a surface of the heating chamber; and depositing a coating of electrically conductive material that at least partially coats the coating of electrically insulating material, wherein the coating of electrically conductive material is configured to act as a Joule heater when supplied with electrical current, and wherein the coating of electrically insulating material prevents any contact between the coating of electrically conductive material and the heating chamber.

Preferably, the coating of electrically insulating material is formed around the surface of the heating chamber by: depositing the coating of electrically insulating material around the surface of the heating chamber.

Preferably, the heating chamber is tubular and the coating of electrically insulating material is formed on a circumferential surface of the heating chamber.

Alternatively, the heating chamber is shaped as a plate or is “C”-shaped. In this case, the coating of electrically insulating material may be formed on the convex part of the heating chamber.

According to a third aspect of the invention, there is provided an aerosol generating device comprising a heating assembly according to the first aspect.

According to a fourth aspect of the invention, there is provided an aerosol generating system comprising an aerosol generating device according to the third aspect and an aerosol substrate.

### BRIEF DESCRIPTION OF DRAWINGS

Embodiments of the invention are now described, by way of example, with reference to the drawings, in which:

FIG. 1 is an exemplary aerosol generating device according to an embodiment of the invention;

FIG. 2 is a schematic cross-sectional view of a heating assembly comprising a coating of electrically insulating material and a coating of electrically conductive material according to an embodiment of the invention;

FIG. 3 is a perspective view of a heating assembly comprising a coating of electrically conductive material formed in a meandrous pattern according to an embodiment of the invention;

FIG. 4 is a perspective view of a heating assembly comprising a coating of electrically conductive material formed in a meandrous pattern according to an embodiment of the invention;

FIG. 5 is a perspective view of a heating assembly comprising a coating of electrically conductive material that entirely surrounds the heating chamber in a circumferential direction according to an embodiment of the invention;

FIG. 6 is a perspective view of a heating assembly comprising a coating of electrically conductive material that entirely surrounds the heating chamber in a circumferential direction according to an embodiment of the invention;

FIG. 7 is a perspective view of a heating assembly comprising a coating of electrically conductive material arranged adjacent to one or more flattened regions of the heating chamber according to an embodiment of the invention;

FIG. 8 is a perspective view of a heating assembly comprising a coating of electrically conductive material arranged adjacent to one or more recessed regions of the heating chamber according to an embodiment of the invention; and

FIGS. 9A, 9B and 9C are perspective views of a heating assembly comprising a coating of electrically conductive material disposed within an interior of the heating chamber according to an embodiment of the invention.

FIG. 10 is a perspective view of a heating assembly comprising a coating of electrically conductive material formed in a meandrous pattern on an exterior of the heating chamber according to an embodiment of the invention.

### DETAILED DESCRIPTION

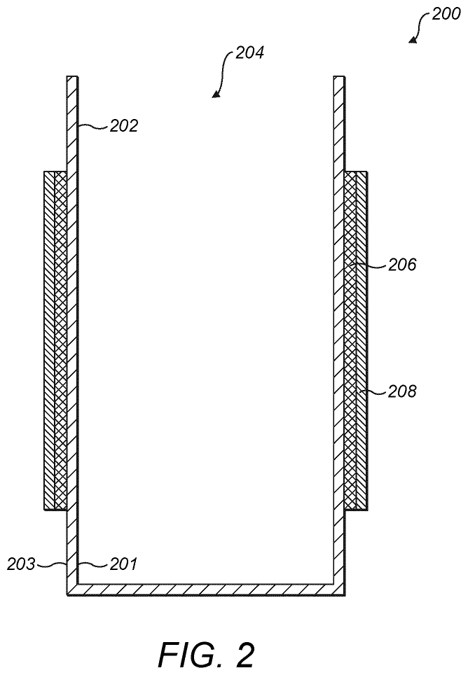

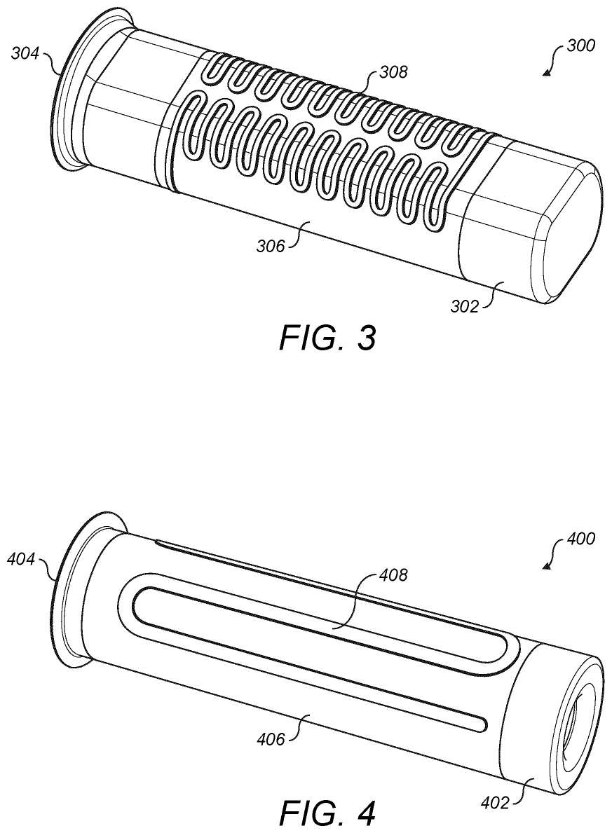

The figures herein follow a numbering convention in which the first digit or digits correspond to the drawing figure number and the remaining digits identify an element or component in the drawing. Similar elements or components between different figures may be identified by the use of similar digits. For example, 206 may reference element “06” in FIG. 2, and a similar element may be referenced as 306 in FIG. 3. The skilled person will appreciate that the description of the properties and configuration of each element may equally apply to corresponding elements in other embodiments.

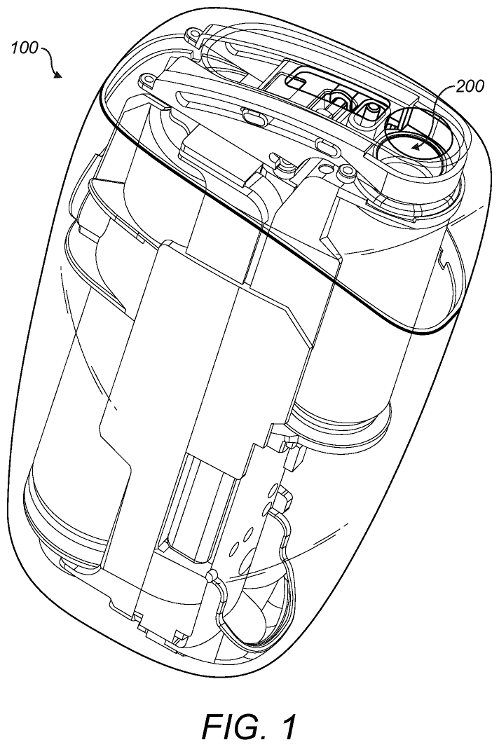

FIG. 1 illustrates an aerosol generating device 100 according to an embodiment of the invention. The aerosol generating device 100 is illustrated in an assembled configuration with the internal components visible. The aerosol generating device 100 is a heat-not-burn device, which may also be referred to as a tobacco-vapour device, and comprises a heating assembly 200 configured to receive an aerosol substrate such as a rod of aerosol generating material, e.g. tobacco. The heating assembly 200 is operable to heat, but not burn, the rod of aerosol generating material to produce a vapour or aerosol for inhalation by a user. Of course, the skilled person will appreciate that the aerosol generating device 100 depicted in FIG. 1 is simply an exemplary aerosol generating device according to the invention. Other types and configurations of tobacco-vapour products, vaporisers, or electronic cigarettes may also be used as the aerosol generating device according to the invention.

FIG. 2 shows a cross-sectional schematic view of the heating assembly 200 according to an embodiment of the invention. The heating assembly 200 comprises a heating chamber 202, also referred to as a thermally conductive shell, configured to hold an aerosol substrate, also referred to as a consumable, therein. In particular, the heating chamber 202 defines a substantially cylindrical cavity in which a rod of aerosol substrate may be positioned. The heating chamber 202 is tubular, e.g. substantially cylindrical, and has an opening 204 positioned at a longitudinal end of the heating chamber 202. In use, the user may insert the aerosol substrate through the opening 204 in the heating chamber 202 such that the aerosol substrate is positioned within the heating chamber 202 and interfaces with an inner surface 201 of the heating chamber 202. The length of the heating chamber 202 may be configured such that a portion of the aerosol substrate protrudes through the opening 204 in the heating chamber 202, i.e. out of the heating assembly 200, and can be received in the mouth of the user.

The heating chamber 202 comprises, and preferably consists of, metal such that an efficient transfer of heat is provided through a side wall of the heating chamber 202 to the aerosol substrate whilst also ensuring that the heating chamber 202 has sufficient structural stability and durability. Examples of suitable metals include steel or stainless steel or aluminium.

The thickness of the (circumferential) side wall of the heating chamber 202 is preferably 0.1 mm or less, or more preferably between 0.07 and 0.09 mm. This allows for efficient heat transfer through the side wall of the heating chamber 202 to a consumable while maintaining sufficient structural stability. The heating chamber 202 has a closed end opposite the opening 204, wherein the closed end preferably has a thickness of 0.2 to 0.6 mm, which adds further structural rigidity to the heating chamber 202. The method of manufacturing the heating chamber 202 is described in co-pending PCT/EP2020/074147.

The skilled person will appreciate that the heating chamber 202 is not limited to being cylindrical. For example, the heating chamber 202 may be formed as a cuboidal, conical, hemi-spherical or other shaped cavity, and be configured to receive a complementary shaped aerosol substrate. Moreover, in some embodiments, the heating chamber 202 may not entirely surround the aerosol substrate, but instead only contact a limited area of the aerosol substrate.

For example, the heating chamber 202 may be substantially cylindrical but comprise one or more elongate recessed regions that protrude inwardly to form elongate protrusions on the inner surface 201 of the heating chamber 202, as described later with reference to FIGS. 6 and 8. The recessed regions may be produced by pressing into an outer surface 203 of the heating chamber 202 as fluid is injected under pressure into the heating chamber 202 to provide a plurality of corresponding elongate protrusions running lengthwise on the inner surface 201 of the heating chamber.

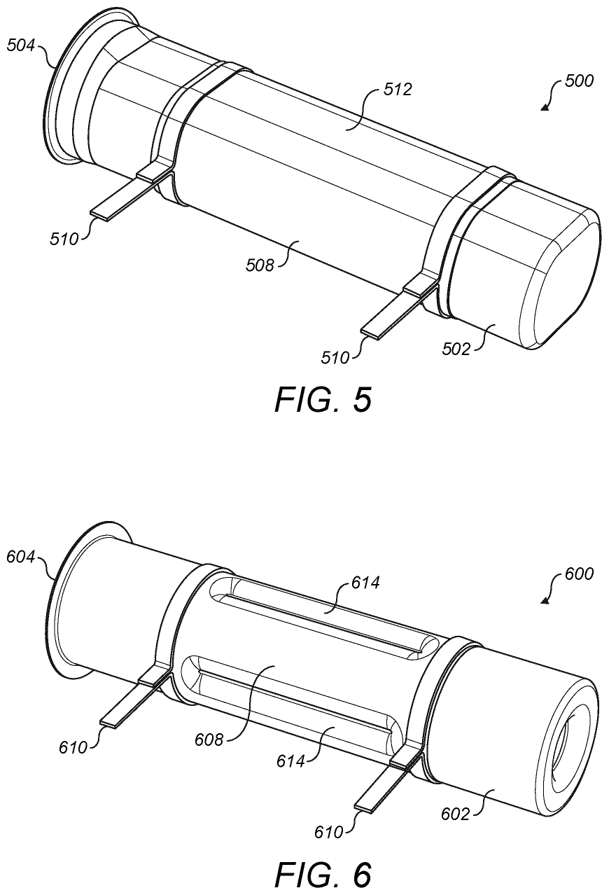

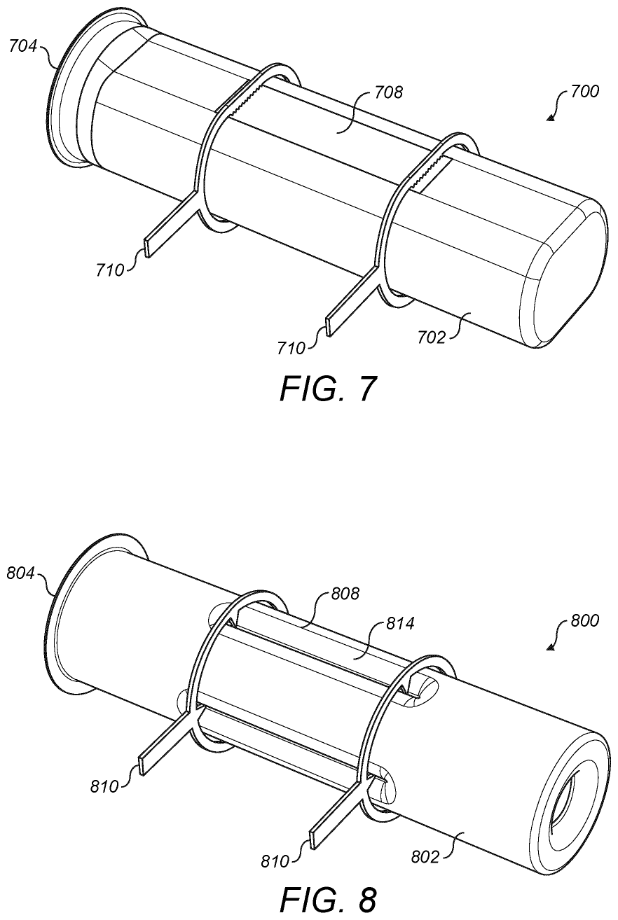

In another example, the heating chamber 202 may be substantially cylindrical but comprise one or more flattened regions that extend in an axial direction of the heating chamber 202, as described later with reference to FIGS. 5 and 7. In this case, the heating chamber 202 may be configured such that a rod of aerosol substrate received within the heating chamber 202 is compressed by the one or more flattened regions of the heating chamber 202. The other regions of the circumferential surface of the heating chamber (i.e. the sections of heating chamber connecting the one or more flattened regions) may be configured such that they do not contact the received rod of aerosol substrate, thereby forming one or more airflow channels along the length of the heating chamber. A coating of electrically insulating material 206, also referred to as an electrically insulating layer, surrounds an outer surface 203 of the heating chamber 202. In particular, the coating of electrically insulating material 206 lies adjacent to (i.e. abuts, contacts) the circumferential outer surface 203 of the heating chamber 202. The coating of electrically insulating material 206 is directly bonded to the outer surface 203 of the heating chamber 202, i.e. chemical bonds are formed between the coating of electrically insulating material 206 and the heating chamber 202. In FIG. 2, the coating of electrically insulating material 206 is depicted as only extending along a portion of the length of the outer surface 203 of the heating chamber 202. However, the skilled person will appreciate that, in other embodiments, the coating of electrically insulating material 206 may extend along the entire length of the heating chamber 202. Moreover, the skilled person will appreciate that the coating of electrically insulating material 206 may only partially surround the outer surface of the heating chamber 202.

The coating of electrically insulating material 206 preferably comprises a material exhibiting a high electrical breakdown voltage (e.g. at about 100 Volt or higher) and high thermal conductivity. For example, the coating of electrically insulating material 206 may comprise ceramic, silicone, glass, silicone oxide, carbon or a combination thereof. In another example, the coating of electrically insulating material 206 may comprise (or optionally consist of) diamond-like-carbon (DLC). Preferably, the coating of electrically insulating material 206 has a thickness of between 0.3 to 10 microns, more preferably between 0.5 and 6 microns. Such properties provide improved heat transfer to the aerosol substrate received within the heating chamber 202, whilst ensuring that the heating chamber 202 remains electrically insulated. Advantageously, the heat-up time and cool-down time of the heating chamber 202 may be reduced, thereby improving the energy efficiency of the heating assembly 200.

A coating of electrically conductive material 208 overlays (i.e. coats) the coating of electrically insulating material 206. That is, the coating of electrically conductive material 208 is directly bonded to the coating of electrically insulating material 206 on an opposite side the coating of electrically insulating material 206 to the heating chamber 202. In this way, chemical bonds are formed between the coating of electrically conductive material 208 and the coating of electrically insulating material 206 which ensures complete adherence between the layers.

The coating of electrically conductive material 208 is configured to operate as a Joule heater. In other words, the coating of electrically conductive material 208 is configured to release heat in response the flow of electrical current. This physical effect may be referred to as Joule heating, resistive heating or ohmic heating. In use, power may be supplied to the coating of electrically conductive material 208 from a power source such as a battery (not depicted) such that the temperature of the coating of electrically conductive material 208 increases and heat energy is transferred across the coating of electrically insulating material 206 to the heating chamber 202. The aerosol substrate received within the heating chamber 202 is conductively heated by the heating chamber 202 to produce an aerosol for inhalation by the user.

The coating of electrically conductive material 208 preferably comprises metal. For example, the coating of electrically conductive material 208 may comprise preferably primarily, (and optionally consists of) titanium. In another example, the coating of electrically insulating material may comprise (and optionally consists of) silver or silver ink. In particular, the coating of silver ink may be formed by applying silver ink flakes in butyl carbitol onto the coating of electrically insulating material, e.g. by screen printing, and subsequently curing this composition, e.g curing at 340° C. for 20 minutes. The coating may also comprise carbon or metal oxide semiconductors or conductors. Examples of metal oxides are: TiO2, NiO, TiN or TiB2. The electrical conductivity of the material is above 10⁻³ S/m, preferably above 10² S/m, most preferably between 10⁻³ and 10⁷ S/m (at 20° C.).

The coating of electrically conductive material 208 may be deposited or printed using a variety of techniques, including chemical deposition (CVD), physical deposition (PVD), thermal evaporation, vacuum evaporation, metal beam evaporation, sputtering, pulsed laser deposition, Arc-PVD (cathodic arc deposition), ink jet, gravure, or screen printing.

The skilled person will appreciate that the heating chamber 202 is not a resistive heater, and therefore should not receive a current. Thus, the coating of electrically insulating material 206 advantageously prevents a short circuit occurring between the heating element 208 and the heating chamber 202 by preventing contact between the coating of electrically conductive material 208 and the heating chamber 202, whilst allowing an efficient transfer of heat from the coating of electrically conductive material 208 to the heating chamber 202. That is, the coating of electrically insulating material 206 separates the coating of electrically conductive material 208 and the heating chamber 202 and ensures that a current does not flow from the coating of electrically conductive material 208 to the heating chamber 202.

As the heating chamber 202, the coating of electrically insulating material 206, and the coating of electrically conductive material 208 form direct bonds with one another (i.e. they are chemically bonded at their interfaces) no air gaps or other thermal breaks exist between the components. Advantageously, this limits the thermal losses during operation and significantly improves the energy efficiency of the heating assembly 200.

In the embodiment illustrated in FIG. 2, the coating of electrically conductive material 208 is formed as a continuous surface that entirely surrounds the coating of electrically insulating material 206 in a circumferential direction of the heating chamber. That is, the coating of electrically conductive material 208 covers the coating of electrically insulating material 206 such that no portion of the coating of electrically insulating material 206, at least in the circumferential direction, is exposed. However, as will be discussed below, in alternative embodiments the coating of electrically conductive material 208 may only partially cover the coating of electrically insulating material 206 and may be arranged in various patterns and configurations.

FIG. 3 shows a heating assembly 300 according to another embodiment of the invention. In this embodiment, a coating of electrically conductive material 308 is formed as a meandrous or serpentine pattern on the coating of electrically insulating material 306. For example, the coating of electrically conductive material 308 may be shaped by etching, masking, laser cutting, or screen printing to form the illustrated pattern. Of course, the skilled person will appreciate that the specific pattern formed by the coating of electrically conductive material 308 may vary, depending on the functional requirements of the heating assembly 300. The pattern forms an electrical path such that, in use, electrical current supplied to the coating of electrically conductive material 308 travels along the electrical path and generates heat energy.

FIG. 4 shows a heating assembly according to another embodiment of the invention, in which a coating of electrically conductive material 408 is formed as a meandrous pattern in a different arrangement to the pattern in FIG. 3. The coating of electrically conductive material 408 is patterned to form a strip of electrically conductive material that winds across the coating of electrically insulating material 406. The path formed by the coating of electrically conductive material 408 acts as an electrical path along which current is supplied, and is able to provide a uniform heat distribution to the aerosol substrate received within the heating chamber 402.

In other examples, the coating of electrically conductive material 308, 408 may be patterned and/or shaped for one or more additional functions. For example, the coating of electrically conductive material 308, 408 may be shaped to create a specific pattern which functions as, for example, a thermistor or an antenna.

FIGS. 5 and 6 illustrate two alternative embodiments in which a coating of electrically conductive material 508, 608 is applied as an unbroken surface of electrically conductive material which entirely envelops a coating of electrically insulating material 506, 606. That is, the coating of electrically conductive material 508, 608 surrounds the heating chamber 502, 602 in a circumferential direction such that the coating of electrically insulating material 506, 606 is not exposed.

In FIG. 5, the heating chamber 502 is a tubular member comprising two flattened regions 512 formed on opposing sides of the heating chamber 502, extending in an axial direction of the heating chamber 502. However, the skilled person will appreciate that the number of flattened regions 512 may be three or more, the flattened regions 512 being spaced around the circumference of the heating chamber 502. The regions of the heating chamber 502 between the flattened regions 512 may be referred to as curved regions.

Advantageously, in use, when an aerosol substrate (e.g. a cylindrical aerosol substrate) having a diameter larger than the distance between the flattened regions 512 is received within the heating chamber 502, the flattened regions 512 will compress abutting regions of the aerosol substrate. Therefore, a flush interface is formed between each flattened region 512 and the aerosol substrate, resulting in improved heat transfer. At the same time, the diameter of the aerosol substrate may be less than the radial distance between the curved regions of the heating chamber 502, such that the curved regions do not contact the aerosol substrate and two airflow channels are defined between the aerosol substrate and the curved regions of the heating chamber 502 along the length of the heating chamber 502.

The heating assembly 510 further comprises two electrodes 510 (also referred to as electrical connectors) located at axially distant regions of the electrically conductive material 508, e.g. at opposing ends of the electrically conductive material 508 in the axial direction of the heating chamber 502. Each electrode 510 is configured as a wire or band which forms a ring that circumferentially surrounds and interfaces with the coating of electrically conductive material 508. In this way, an electrical path may be formed from one electrode 510 to the other electrode 510 via the coating of electrically conductive material 508. Thus, when electrical current is supplied to one of the electrodes 510, electrical current travels through the coating of electrically conductive material 508 and generates heat around the entire circumference of the heating chamber 502.

In FIG. 6, the heating chamber 602 is a tubular member comprising a plurality of recessed regions 614, which may also be referred to as longitudinal indentations. The recessed regions 614 extend parallel to the length of the heating chamber 602 and form elongate protrusions on the inner surface 601 of the heating chamber 602. In other words, the protrusions protrude towards the interior of the cavity. Thus, when an aerosol substrate is received within the heating chamber 602, the elongate protrusions provide increased contact with the aerosol substrate, resulting in a concentrated heating effect. The coating of electrically conductive material 608 is formed as a uniform layer across the coating of electrically insulating material 606. In particular, the coating of electrically conductive material 608 is also formed within the recessed regions 614. Similar to FIG. 5, the heating assembly 600 comprises annular electrodes 610 which encircle and interface with the coating of electrically conductive material 608. In both embodiments, as the electrodes 510, 610 interface with the coating of electrically conductive material 508, 608, they may produce focused heating areas.

FIGS. 7 and 8 illustrate two alternative embodiments in which a coating of electrically conductive material 708, 808 is only formed on selected regions of the heating chamber 702, 802. In particular, the coating of electrically conductive material 708, 808 is formed as a plurality circumferentially spaced bands that extend in an axial direction of the heating chamber 702, 802.

In FIG. 7, the heating chamber 702 is the same shape as the heating chamber 502 in FIG. 5, but the coating of electrically conductive material 708 (and underlying coating of electrically insulating material 706, as visible by reference 206 in FIG. 2) is only located adjacent to the flattened regions 712 of the heating chamber 702 and does not extend around the entire circumference of the heating chamber 702. That is, the coating of electrically conductive material 708 is formed as a plurality (e.g. two) axial bands which coincide with the flattened regions 712 of the heating chamber 702. In the way, when supplied with electrical current via the electrodes 710, the coating of electrically conductive material 708 provides a focused heating effect which preferentially heats regions of the aerosol substrate received within the heating chamber 702 which are adjacent to the flattened regions 712. The electrodes 710 are formed as substantially annular bands or wires which surround the heating chamber 702 and interface with the coating of electrically conductive material 708 on each side of the heating chamber 702, corresponding to the flattened regions 712, at axially distant points along the length of the heating chamber 702. In the depicted embodiment, the coating of electrically insulating material 706 is also only formed on the flattened regions 712, coincident with (i.e. exactly underlying) the coating of electrically conductive material 708, and does not surround the heating chamber 702. As a result, the electrodes 710 are arranged such that the electrodes 710 only contact the heating chamber 702, and in particular the coating of electrically conductive material 708, adjacent to the flattened regions 712 of the heating chamber 702. In this way, the electrodes 710 do not directly contact the outer surface of the heating chamber 702, and an air gap is provided between the electrodes 710 and the outer surface of the heating chamber 702 around the remainder of the circumference of the heating chamber 702.

However, the skilled person will appreciate that, in alternative embodiments, the coating of electrically insulating material 706 may entirely surround the heating chamber 702 in a circumferential direction. In this case, the electrodes 710 may contact the heating chamber 702, and in particular the electrically insulating material 706 and the electrically conductive material 708, around the entire circumference of the heating chamber 702.

In FIG. 8, the heating chamber 802 is the same shape as the heating chamber 602 in FIG. 6, but the coating of electrically conductive material 808 (and underlying coating of electrically insulating material 806) is located coincident with (e.g. within) the recessed regions 814, and does not extend around the entire circumference of the heating chamber 802. That is, the coating of electrically conductive material 808 is formed as a plurality of axial bands extending adjacent to the recessed regions 814. In the way, when supplied with electrical current via the electrodes 810, the coating of electrically conductive material 808 provides a focused heating effect which preferentially heats the aerosol substrate received within the heating chamber 802 at portions of the aerosol substrate adjacent to the recessed regions 814. In other words, the respective portions of the aerosol substrate which are contacted by the elongate protrusions formed on the inner surface 801 of the heating chamber 802 receive a greater amount of thermal energy. Again, the electrodes 810 are formed as annular bands or wires which surround the heating chamber 802 and interface with the coating of electrically conductive material 808 at the recessed regions 814, and at axially distant regions along the length of the heating chamber 802.

In the depicted embodiment, the coating of electrically insulating material 806 is only formed within the recessed regions 814, coincident with (i.e. exactly underlying) the coating of electrically conductive material 808, and does not surround the heating chamber 802. As a result, the electrodes 810 are arranged such that the electrodes 810 only contact the heating chamber 802, and in particular the coating of electrically conductive material 808, adjacent to the recessed regions 814 of the heating chamber 802. In particular, the electrodes can be formed of a ring circumferentially arranged about the heating chamber and distant from the heating chamber and comprising radial protrusions, e.g. small strips or tabs, contacting the recessed regions 814. In this way, the electrodes 810 do not directly contact the outer surface of the heating chamber 802, and an air gap is provided between the electrodes 810 and the outer surface of the heating chamber 802 around the remainder of the circumference of the heating chamber 802.

However, the skilled person will appreciate that, in alternative embodiments, the coating of electrically insulating material 806 may entirely surround the heating chamber 802 in a circumferential direction. In this case, the electrodes 810 may contact the heating chamber 802, and in particular the electrically insulating material 906 and the electrically conductive material 908, around the entire circumference of the heating chamber 802.

The axial bands of coating of electrically conductive material 708, 808 may be formed using a variety of deposition or printing techniques as discussed previously, such as metal evaporation or screen printing.

The skilled person will appreciate that, in alternative embodiments, the plurality of circumferentially spaced bands of electrically conductive material 708, 808 and underlying electrically insulating material 706, 806 may instead by formed on an inner surface 701, 801 of each heating chamber 702, 802. For example, the coating of electrically insulating material 706 may be formed as a plurality (e.g. two) axial bands on the inner surface 701 of the flattened regions 712 of the heating chamber 702. The coating of electrically conductive material 708 may be formed on the coating of electrically insulating material 706, thereby forming corresponding and overlying axial bands of electrically conductive material that are exposed to the interior of the heating chamber 702. Similarly, the coating of electrically insulating material 806 may be formed as a plurality (e.g. two) axial bands on the inner surface 801 of the heating chamber 808 coincident to the recessed regions 814. The coating of electrically conducting material 808 may be formed on the coating of electrically insulating material 806, thereby forming corresponding and overlying axial bands of electrically conductive material that are exposed to the interior of the heating chamber 802. That is, the electrically conductive material 808 protrudes into the interior of the heating chamber 802.

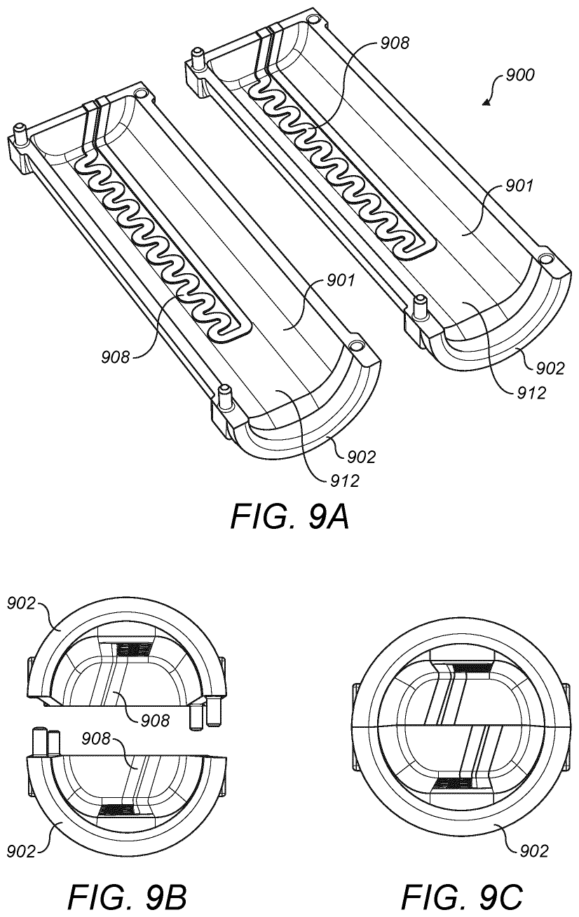

FIGS. 9A, 9B and 9C show various perspective views of a heating assembly 900 according to another embodiment of the invention. In contrast to the previously illustrated embodiments, the heating assembly 900 comprises a coating of electrically insulating material 906 that is formed on an inner surface 901 of the heating chamber 902. The coating of electrically conductive material 908 overlays the coating of electrically insulating material 906, such that coating of electrically conductive material 908 is located within the interior of the heating chamber 902. Thus, when an aerosol substrate is received within the heating chamber 902, the coating of electrically conductive material 908 directly contacts and transfers heat to the aerosol substrate.

As illustrated in FIG. 9A, the coating of electrically conductive material 908 is formed as a meandering pattern adjacent to each flattened region 912 of the heating chamber 902. However, in alternative embodiments, the coating of electrically conductive material 908 may be formed as an unbroken surface that entirely surrounds the inner surface 901 of the heating chamber 902. Moreover, the skilled person will appreciate that the shape of the heating chamber 902 may vary, as previously discussed.

In this embodiment, the coating of electrically insulating material 906 directly underlays the coating of electrically conductive material 908, i.e. the two coatings exactly coincide so the coating of electrically insulating material 906 is not exposed. However, in alternative embodiments, the coating of electrically conductive material 908 may only partially cover the coating of electrically insulating material 906. For example, the coating of electrically insulating material 906 may extend around the entire inner surface 901 of the heating chamber 902 in a circumferential direction.

As illustrated in FIGS. 9A and 9B, the heating chamber 902 comprises two separable body sections. The coating of electrically conductive material 908 is arranged to form an electrical path that enters and exits the interior of the heating chamber 902 via the interface between the body sections. Hence, the coating of electrically conductive material 908 may be safely connected to a power source without exposing the coating of electrically conductive material 908 at the opening 904 of the heating chamber 902.

The separate body sections of the heating chamber may be formed of heat resistant polymer material such as PEEK. They can be produced by injection moulding. They can be assembled to form the heating chamber by press-fitting and/or adhesion such as ultrasonic welding or gluing. Each body may comprise coupling elements along the assembly joins to provide proper guidance and fit during assembling.

The skilled person will appreciate that in alternative embodiments, the heating chamber 902 may be formed as a single unit, rather than having separable body sections. The skilled person will also appreciate that the heating chambers of all the previous embodiments may comprise two separable body sections.

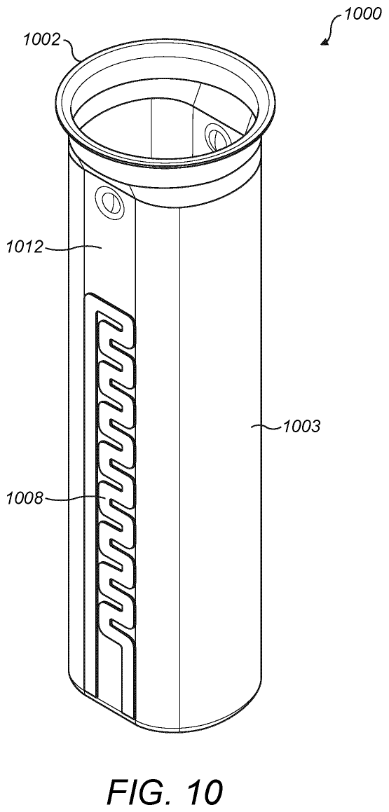

FIG. 10 shows a perspective view of a heating assembly 1000 according to another embodiment of the invention. The heating assembly 1000 corresponds to the heating assembly 900 of FIGS. 9A, 9B and 9C in that the coating of electrically conductive material 1008 is formed as a meandering pattern adjacent to each flattened region 1012 of the tubular heating chamber 1002. However, in this embodiment, the coating of electrically insulating material 1006 is formed on an outer surface 1008 of the heating chamber 100. The coating of electrically conductive material 1008 is formed on the coating of electrically insulating material 1006, such that the coating of electrically conductive material 1008 directly overlays the coating of electrically insulating material 1006 and follows the same meandering pattern.

In FIG. 10 the heating chamber 1002 is illustrated as being formed as a single unit, but the skilled person will appreciate that in alternative embodiments the heating chamber 1002 may also be comprise two separable body portions as described with respect to FIGS. 9A, 9B and 9C.

1. A heating assembly for an aerosol generating device, comprising:
a heating chamber having an opening for receiving an aerosol substrate;
a coating of electrically insulating material that is formed on a surface of the heating chamber; and
a coating of electrically conductive material that at least partially coats the coating of electrically insulating material,
wherein the coating of electrically conductive material is configured to act as a Joule heater when supplied with electrical current, and
wherein the coating of electrically insulating material prevents any contact between the coating of electrically conductive material and the heating chamber.

2. The heating assembly of claim 1, wherein the heating chamber is tubular, and wherein the coating of electrically insulating material is formed on a circumferential surface of the heating chamber.

3. The heating assembly of claim 1, wherein the coating of electrically conductive material is chemically bonded to the coating of electrically insulating material.

4. The heating assembly of claim 1, wherein the coating of electrically conductive material is deposited on the coating of electrically insulated material by physical or chemical deposition.

5. The heating assembly of claim 1, wherein the coating of electrically conductive material is metal, metal oxide or carbon.

6. The heating assembly of claim 1, wherein the coating of electrically conductive material is formed as a meandrous pattern on the coating of electrically insulating material.

7. The heating chamber of claim 2, wherein the coating of electrically conductive material is formed as an unbroken surface that entirely surrounds the coating of electrically insulating material in a circumferential direction of the heating chamber.

8. The heating chamber of claim 2, wherein the coating of electrically conductive material is formed as a plurality of circumferentially spaced bands that extend in an axial direction of the heating chamber.

9. The heating chamber of claim 2, wherein the circumferential surface of the heating chamber on which the coating of electrically insulating material is formed is an outer surface of the heating chamber.

10. The heating assembly of claim 2, wherein the circumferential surface of the heating chamber on which the coating of electrically insulating material is formed is an inner surface of the heating chamber.

11. The heating assembly of claim 1, further comprising a first electrode connected to a first axial end of the coating of electrically conductive material and a second electrode connected to a second opposing axial end of the coating of electrically conductive material such that, in use, electrical current may flow from the first electrode to the second electrode via the coating of electrically conductive material.

12. The heating assembly of claim 11, wherein the first electrode and the second electrode are each formed as a ring that surrounds the heating chamber in a circumferential direction.

13. The heating assembly of claim 1, wherein the heating assembly comprises local contacts of a third material disposed on the surface of the coating of electrically conductive material, wherein the local contacts are configured to be connected to electrical wires using a brazing material.

14. The heating assembly of claim 1, wherein the outer surface of the heating chamber has one or more recessed regions that extend in an axial direction of the heating chamber.

15. A method of manufacturing a heating assembly for an aerosol generating device, comprising:
providing a heating chamber having an opening for receiving an aerosol substrate;
forming a coating of electrically insulating material on a surface of the heating chamber; and
forming a coating of electrically conductive material on the coating of electrically insulating material, wherein the coating of electrically conductive material at least partially coats the coating of electrically insulating material, wherein the coating of electrically conductive material is configured to act as a Joule heater when supplied with electrical current, and wherein the coating of electrically insulating material prevents any contact between the coating of electrically conductive material and the heating chamber.

16. The heating assembly of claim 14, wherein the coating of electrically conductive material is formed coincident to the one or more recessed regions.
